(19) United States
(12) Patent Application Publication
(10) Pub. No.: US 2005/0160266 A1
(43) Pub. Date: Jul. 21, 2005

(54) Data retransmission device and method

(75) Inventor: Yang-lim Choi, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS., LTD.

(21) Appl. No.: 11/035,106

(22) Filed: Jan. 14, 2005

(30) Foreign Application Priority Data
Jan. 16, 2004 (KR) 10-2004-0003243

(51) Int. Cl. H04L 9/00; G11C 5/00

(52) U.S. Cl. 713/168

(57) ABSTRACT

A data retransmission device and method are provided that can simultaneously implement link protection and internal protection without increasing design complexity and cost. A data retransmission device for encrypting input data and retransmitting the encrypted data to a predetermined device includes an input data processing unit receiving the input data, coding the input data in a format suitable for the predetermined device, and encrypting the input data with a common key to be shared with the predetermined device, and a link protection unit receiving the encrypted input data from the input data processing unit via a predetermined bus and retransmitting the received data to the predetermined device. In addition, the common key is created in the link protection unit and transmitted to the input data processing unit via the predetermined bus.

### BACKGROUND OF THE INVENTION

This application claims priority from Korean Patent Application No. 2004-3243, filed on Jan. 16, 2004 in the Korean Intellectual Property Office, the disclosure of which is incorporated herein in its entirety by reference.

1. Field of the Invention

The present invention relates to a data retransmission device and method that implements link protection between devices, and more particularly, to a data retransmission device and method that can simultaneously implement link protection and internal protection by using a key employed in an encryption operation for the link protection in an encryption operation for the internal protection of the data retransmission device.

2. Description of Related Art

Digital transmission content protection (DTCP) for preventing unauthorized copying of digital content retransmitted from a source device, such as a digital video cassette recorder (VCR) or a digital set-top box, to a sink device, such as a digital TV, is currently used as a standard protocol for link protection between devices.

A basic structure of DTCP is designed so that a source device authenticates that a sink device is licensed to receive protected content, creates a common secret key, encrypts digital content, and transmits the encrypted content to a sink device. That is, when a content transmission request is initially sent from the sink device to the source device, the source device checks copyright information of the content to be transmitted. If the copyright information indicates that the content is not “copy-free∞ but copyrighted, a stream of the content is encrypted using an encryption module, and the encrypted content stream embedded with encryption mode indicator (EMI) is transmitted to the sink device through a digital interface such as IEEE 1394. When the copyright information indicates that the received content stream is not “copy-free”, the sink device determines this content stream to have been encrypted and requires mutual authentication to the source device. When a mutual authentication request is sent from the sink device to the source device, the sink and source devices are subjected to a mutual authentication process according to regulations specified in a link protection protocol such as DTCP. If the mutual authentication process is successful, encryption/decryption keys are exchanged for establishing a secure digital encryption channel between the source and sink devices. If the mutual authentication process is not successful, the source device determines the sink device to be unreliable and stops transmitting the content stream. When the encryption channel is established, the source device sends the encrypted content stream to the source device through the encryption channel.

Although the link protection between the source and sink devices is secured by DTCP, internal protection is required for the security of data flow from an input module to a transmission module of the source device. Particularly, a Peripheral Component Interconnect (PCI) bus based digital set-top box is weak in security since unencrypted data is physically accessible through a PCI slot. Accordingly, the content stream has been conventionally encrypted for the internal protection of the source device with a key different from one used in an encryption operation for the link protection in the input module of the source device. Otherwise, the internal protection has been physically realized by connecting a dedicated bus between the input module and the transmission module of the source device.

However, realizing the internal protection by encrypting the content stream with a key different from one used in an encryption operation for the link protection in the input module of the source device results in encrypting the content stream twice in the source device. In particular, there are problems in that setting an encryption key used in internal protection to a fixed value is weak in security and a design cost required for correctly creating and authenticating an encryption key is increased.

In addition, physically blocking an access to the content stream by connecting a dedicated bus between the input module and the transmission module of the source device has a problem in that hardware design and maintenance is difficult and the cost thus increases. While the source and sink devices are currently wire-connected to each other via an IEEE 1394 bus or a Universal Serial Bus (USB), a wireless communication interface, such as a local area network (LAN) card, will be employed in the source device for establishing a wireless communication link between devices in the future. In this case, it is very difficult to physically combine the input module of the source device with the wireless communication interface and thus there are many limitations in physically realizing the internal protection.

### SUMMARY OF THE INVENTION

According to an aspect of the present invention a data retransmission device and method are provided that can simultaneously implement link protection and internal protection without increasing design complexity and cost.

In particular, according to an aspect of the present invention a data retransmission device and method are provided that can implement internal protection without increasing design complexity and cost by encrypting digital content of an input module with a content key created in a link protection module.

According to an aspect of the present invention, there is provided a data retransmission device for encrypting input data and retransmitting the encrypted data to a predetermined device, comprising: an input data processing unit receiving the input data, coding the input data in a format suitable for the predetermined device, and encrypting the input data with a common key to be shared with the predetermined device; and a link protection unit receiving the encrypted input data from the input data processing unit via a predetermined bus and retransmitting the received data to the predetermined device.

In addition, the common key may be created in the link protection unit and transmitted to the input data processing unit. The link protection unit may encrypt the common key, and the input data processing unit may receive and decrypt the encrypted common key from the link protection unit through the predetermined bus, and encrypt the input data with the decrypted common key. In addition, the link protection unit may create the common key according to copy control information included in the input data, and the link protection unit may create the common key according to the DTCP protocol.

In addition, the input data processing unit may encrypt the input data according to copy control information included in the input data.

In addition, the input data processing unit may comprise a receiving unit receiving the input data, a coding unit coding the received input data in a format suitable for the predetermined device, and an encryption unit encrypting the coded input data.

In addition, when the input data is a digital broadcast signal, the input data processing unit may include a decoding unit decoding the digital broadcast signal, and the decoding unit may include a copy control information detection module detecting copy control information included in the digital broadcast signal, and an encryption module encrypting the digital broadcast signal decoded in accordance with detection results of the copy control information detection module. When the input data is analog/digital content input from an external playback device, the input data processing unit may include an encoding unit encoding the analog/digital content, and the encoding unit may include a copy control information detection module detecting copy control information included in the analog/digital content, and an encryption module encrypting the analog/digital content encoded in accordance with detection results of the copy control information detection module.

In addition, the predetermined bus may be a PCI bus. The link protection unit may retransmit the encrypted input data to the predetermined device via a wire or wireless communication channel.

According to another aspect of the present invention, there is provided a data retransmission method of encrypting input data and retransmitting the encrypted data to a predetermined device, comprising: (a) receiving the input data, coding the input data in a format suitable for the predetermined device, and encrypting the input data with a common key to be shared with the predetermined device in a data input stage; and (b) receiving the encrypted input data via a predetermined bus and retransmitting the received data to the predetermined device in a data retransmission stage.

In addition, operation (b) may further comprise creating the common key. Operation (b) may further comprise encrypting the created common key, and operation (a) may receive and decrypt the encrypted common key from the data retransmission stage via the predetermined bus, and encrypt the input data with the decrypted common key.

In addition, in operation (b), the common key may be created according to copy control information included in the input data, and the common key may be created according to the DTCP protocol.

In addition, in operation (a), the input data may be encrypted according to copy control information included in the input data.

In addition, the predetermined bus may be a PCI bus. In operation (b), the encrypted input data may be transmitted to the predetermined device via a wire or wireless communication channel.

According to another aspect of the present invention, there is provided an audio/video (AV) stream information retransmission device for receiving predetermined AV stream information and retransmitting the received information to a predetermined device, comprising: a receiving unit receiving the predetermined AV stream information; a link protection unit creating a common key through an authentication process with the predetermined device; and an encryption unit encrypting the AV stream information using the common key.

The link protection unit may encrypt the common key created through the authentication process, and the encryption unit may decrypt the encrypted common key.

According to another aspect of the present invention, there is provided an AV stream information retransmission method of receiving predetermined AV stream information and retransmitting the received information to a predetermined device, comprising: (a) receiving the predetermined AV stream information; (b) creating a common key through an authentication process with the predetermined device; and (c) encrypting the AV stream information using the common key.

Operation (b) may further comprise encrypting the created common key, and operation (c) may further comprise decrypting the encrypted common key.

### BRIEF DESCRIPTION OF THE DRAWINGS

FIG. 1 shows a network system including a data retransmission device according to an exemplary embodiment of the present invention;

FIG. 2 shows a data retransmission device according to an exemplary embodiment of the present invention;

FIG. 3 shows a configuration example of an input data processing unit of the data retransmission device shown in FIG. 2;

FIG. 4 shows another configuration example of an input data processing unit of the data retransmission device shown in FIG. 2; and

FIG. 5 shows a flowchart of a data retransmission method according to an exemplary embodiment of the present invention.

### DETAILED DESCRIPTION OF EXEMPLARY EMBODIMENTS OF THE INVENTION

Exemplary embodiments according to the present invention will now be described in detail with reference to the accompanying drawings.

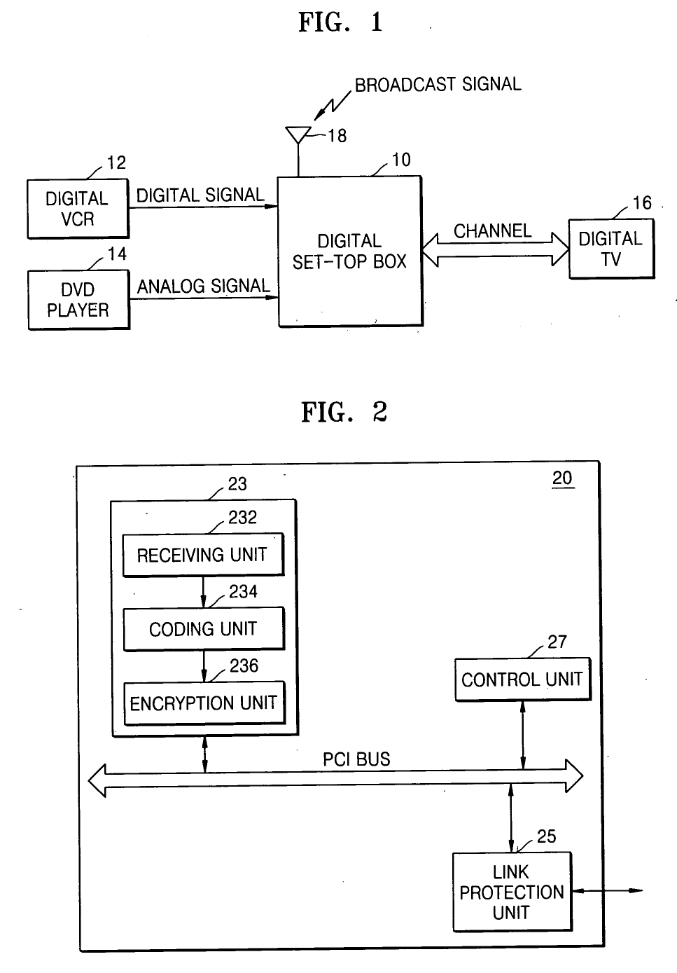

FIG. 1 shows a network system where a digital set-top box 10, which is a data retransmission device according to an exemplary embodiment of the present invention, receives digital and analog signals from a digital VCR 12 and a DVD player 14, respectively, and receives analog/digital broadcast signals via an antenna 18, and retransmits the signals to a digital TV 16 via wire/wireless communication channels.

Recently, there has been widely used a retransmission method where a digital set-top box rather than a display playback device such as a digital TV receives a broadcast signal and an external input signal, performs a predetermined process for the received signals, and transmits the signals to a digital TV.

FIG. 2 shows a data retransmission device 20 according to an exemplary embodiment of the present invention. The data retransmission device 20 comprises an input data processing unit 23, a link protection unit 25, and a control unit 27. The input data processing unit 23 receives a digital broadcast signal from satellite broadcast, cable broadcast, or terrestrial broadcast and receives a playback signal from a digital content player such as a DVD player and performs a predetermined process, and sometimes encrypts the processed signal. The link protection unit 25 authenticates a sink device such as a digital TV, exchanges a common key with the sink device, and transmits the common key to the input data processing unit 23. The control unit 27 controls data exchange between the input data processing unit 23 and the link protection unit 25. In addition, the data exchange between units of the data retransmission device 20 is made through a PCI bus. The data retransmission device 20 is also referred to as an AV stream retransmission device in case of retransmitting an AV stream.

In addition to the units shown in FIG. 2, the data retransmission device 20 may further comprise a hard disk drive for realizing a personal video recorder (PVR) function, and a buffer memory for realizing a transcoding function to be described later. However, the additional units will not be set forth.

The input data processing unit 23 comprises a receiving unit 232 for receiving data from the external side, a coding unit 234 for coding the received data in a useful format for a sink device, and an encryption unit 236 for encrypting the coded data, in order to perform a predetermined process depending on received data types and encrypt input data with a common key created in the link protection unit 25.

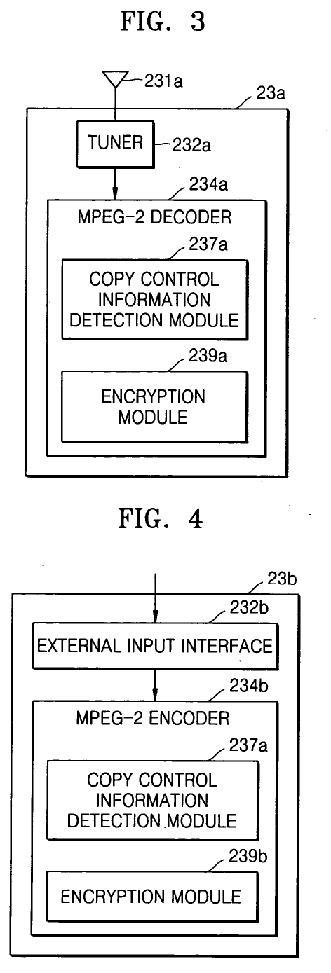

The receiving unit 232 has a different configuration depending on the types of input data. For instance, if the input data is a broadcast signal, the receiving unit 232 may include an antenna 231a and a tuner 232a as shown in FIG. 3. If the input data is a playback signal input from an external playback device such as a DVD player, the receiving unit 232 may include an external input interface 232b as shown in FIG. 4.

The coding unit 234 encodes, decodes, or transcodes input data depending on the types of the input data and the use purposes. For instance, if the input data is a digital broadcast signal, the coding unit 234 may consist of an MPEG-2 decoder 234a of FIG. 3. If the input data is a playback signal input from an external playback device such as a DVD player, the coding unit 234 may consist of an MPEG-2 encoder 234b of FIG. 4.

The encryption unit 236 encrypts the coded input data with a common key created in the link protection unit 25. The encryption unit 236 may be formed separately from the coding unit 234, but is typically included in the coding unit 234 as shown in FIGS. 3 and 4.

Since the input data typically includes copy control information, the input data processing unit 23 encrypts the input data only if the copy control information is not “copy-free”. A detecting operation of the copy control information included in the input data can be performed by the coding unit 234 or the encryption unit 236, or by copy control information detection modules 237a and 237b in the coding unit 234 as shown in FIGS. 3 and 4. Otherwise, a detecting operation of the copy control information may be performed by an additional copy control information detection unit (not shown). In addition, when the common key is encrypted in the link protection unit 25, a decrypting operation of the encrypted common key may be performed in the encryption unit 236 or encryption modules 239a and 239b.

FIG. 3 shows a configuration example of the input data processing unit 23 of FIG. 2 when received data is an MPEG-2 transport stream digital broadcast signal. In the input data processing unit 23a, the MPEG-2 transport stream received via an antenna 231a is selected in a tuner 232a and decoded in an MPEG-2 decoder 234a. The MPEG-2 decoder 234a comprises a copy control information detection module 237a and an encryption module 239a. The copy control information detection module 237a detects copy control information such as a broadcast flag included in a digital broadcast signal during decoding of the MPEG-2 transport stream.

Unless the detected copy control information is “copy-free”, the link protection unit 25 performs an authentication operation with a sink device according to a link protection protocol such as DTCP to exchange a common key, and transmits the created common key to the input data processing unit 23a via a PCI bus. Accordingly, the encryption module 239a encrypts the decoded MPEG-2 transport stream with the common key sent from the link protection unit 25 using an encryption algorithm such as a data encryption standard (DES) or advanced encryption standard (AES) algorithm, and the encrypted stream is retransmitted to the sink device through the link protection unit 25. In addition, as described below, the common key is encrypted in the link protection unit 25 before transmitting to the input data processing unit 23a. Therefore, the encryption module 239a decrypts the encrypted common key and encrypts the decoded MPEG-2 transport stream with the decrypted common key. Otherwise, the input data processing unit 23a may be equipped with an additional common key decryption module for decrypting the encrypted common key.

FIG. 4 shows another configuration example of the data retransmission device 23 shown in FIG. 2 when received data is an analog or digital playback signal received from a digital content playback device such as a DVD player. In the data retransmission device 23b, an analog/digital playback signal is received through an external input interface 232b and encoded into an MPEG-2 transport stream in an MPEG-2 encoder 234b. The MPEG-2 encoder 234b includes a copy control information detection module 237b and an encryption module 239b. The copy control information module 237b, for example, detects copy control information such as a Macrovision bit, which may be included in an analog playback signal, or a copy control information (CCI) bit, which may be included in a digital playback signal.

Unless the detected copy control information is “copy-free”, the link protection unit 25 performs an authentication operation with a sink device according to a link protection protocol such as DTCP to exchange a common key, and transmits the created common key to the input data processing unit 23b via a PCI bus. Accordingly, the encryption module 239b encrypts the MPEG-2 transport stream with the common key sent from the link protection unit 25 using an encryption algorithm such as a DES or AES algorithm, and the encrypted stream is retransmitted to the sink device through the link protection unit 25. In addition, as described below, the common key is encrypted in the link protection unit 25 before being transmitted to the input data processing unit 23b. Therefore, the encryption module 239b decrypts the encrypted common key and encrypts the MPEG-2 transport stream with the decrypted common key. Otherwise, the input data processing unit 23b may be equipped with an additional common key decryption module for decrypting the encrypted common key.

The input data processing unit 23 may include a transcoder for transforming HD into SD data or an MPEG-4 into an MPEG-2 transport stream. The transcoder may typically include an encoder and a decoder, and includes a copy control information detection module and an encryption module like the input data processing unit shown in FIGS. 3 and 4.

When data received in the input data processing unit 23 is not “copy-free” but copyrighted, the link protection unit 25 performs an authentication operation and a common key exchange with a sink device according to a link protection protocol such as DTCP. The created common key is transmitted to the input data processing unit 23 via a PCI bus. The common key can be classified into a session key and a content key. In case of performing link protection according to the DTCP protocol, the session key is first created and the content key is created based on the session key. While the content key is typically transmitted to the input data processing unit 23 as a common key, the session key may be sometimes transmitted to the input data processing unit 23 as a common key. When the session key is a common key, the input data processing unit 23 is configured to create a common key from the session key. In addition, the link protection unit 25 is configured to be connected to a sink device not only through an IEEE 1394 interface, but also through a wireless communication interface such as a LAN card for a wireless communication link.

The control unit 27 controls data transmission/reception between the input data processing unit 23 and the link protection unit 25, and performs the overall control of the units within the device and the device. The function of the control unit 27 is implemented by a CPU or a system controller (ASIC).

Meanwhile, a common key may be drained since the common key is transmitted to the input data processing unit 23 via a PCI bus. Accordingly, the common key is encrypted in the link protection unit 25 and transmitted to the input data processing unit 23. Accordingly, as described above, the input data processing unit 23 is equipped with an additional common key encryption module for decrypting the encrypted common key, or equipped with encryption modules 239a and 239b for decrypting the encrypted common key.

An operation of the data retransmission device 20 according to an exemplary embodiment of the present invention is now set forth. The input data processing unit 23 receives a broadcast signal or an external input signal, and detects copy control information included in the received signal. If the copy control information is not “copy-free”, the link protection unit 25 authenticates a sink device using a link protection protocol such as DTCP, and exchanges a common key with the sink device. Subsequently, the common key is sent to the input data processing unit 23 via a PCI bus, and the input data processing unit 23 encrypts the input data, which is subjected to a predetermined coding process, using the common key. The encrypted input data is retransmitted through the link protection unit 25 to the sink device via the PCI bus. In addition, the link protection unit 25 encrypts the common key, and the encrypted common key is sent to the input data processing unit 23. The input data processing unit 23 decrypts the encrypted common key, and encrypts the input data, which is subjected to a predetermined coding process, using the decrypted common key.

Accordingly, since the data passing through the PCI bus is encrypted, the data is secure from physical hacking through a PCI slot. In addition, since the common key created in a link protection process is used for encrypting the input data in an input stage of the data retransmission device, the link protection and the internal protection can be simultaneously achieved.

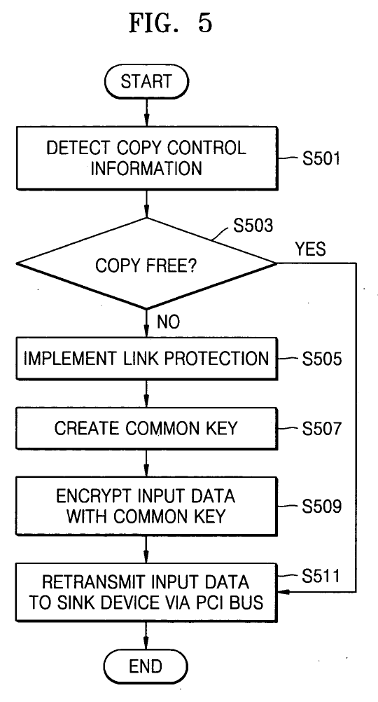

FIG. 5 shows a flowchart of a data retransmission method according to an exemplary embodiment of the present invention. In operation S501, copy control information is detected from an MPEG-2 transport stream digital broadcast signal and/or an analog/digital playback signal from a digital content playback device, which is used as input data. In operation S503, it is determined whether the copy control information is “copy-free”. If the copy control information is “copy-free”, the flow proceeds to operation S511. In operation S511, the input data is retransmitted to a sink device via a PCI bus. If the copy control information is not “copy-free”, the flow proceeds to operation S505. In operation S505, link protection with the sink device is implemented using a link protection protocol such as DTCP. In operation S507, a common key to be shared with the sink device is created in the link protection process. At this time, an operation of encrypting the created common key is added. In operation S509, the input data is encrypted with the common key. When the common key is encrypted, the encrypted common key is decrypted, and the input data is encrypted with the decrypted common key. In operation S511, the encrypted input data is retransmitted to the sink device via the PCI bus.

According to the present invention, it is possible to provide a data retransmission device and method that can simultaneously implement link protection and internal protection without increasing design complexity and cost. In particular, it is possible to provide a data retransmission device and method that can implement internal protection without increasing design complexity and cost by encrypting digital content of an input module with a content key created in a link protection module.

In addition, according to the present invention, it is possible to realize internal protection of a common key itself by encrypting the common key created in a link protection process.

While the present invention has been described with reference to exemplary embodiments thereof, it will be understood by those skilled in the art that various changes in form and details may be made therein without departing from the scope of the present invention as defined by the following claims.

1. A data retransmission device for encrypting input data and retransmitting the encrypted data to a predetermined device, the data retransmission comprising:
an input data processing unit which receives the input data, codes the input data in a format suitable for the predetermined device to generate coded input data, and encrypts the coded input data with a common key to be shared with the predetermined device to generate encrypted input data; and
a link protection unit which receives the encrypted input data from the input data processing unit via a predetermined bus and retransmits the encrypted input data to the predetermined device.

2. The data retransmission device of claim 1, wherein the link protection unit generates the common key and transmits the common key to the input data processing unit.

3. The data retransmission device of claim 2, wherein the link protection unit encrypts the common key, and the input data processing unit receives the common key which has been encrypted from the link protection unit through the predetermined bus, decrypts the common key and encrypts the input data with the common key which has been decrypted.

4. The data retransmission device of claim 2, wherein the link protection unit creates the common key according to copy control information included in the input data.

5. The data retransmission device of claim 2, wherein the link protection unit creates the common key according to a digital transmission content protection (DTCP) protocol.

6. The data retransmission device of claim 1, wherein the input data processing unit encrypts the input data according to copy control information included in the input data.

7. The data retransmission device of claim 1, wherein the input data processing unit comprises:
a receiving unit which receives the input data;
a coding unit which codes the input data in a format suitable for the predetermined device to generate the coded input data; and
an encryption unit which encrypts the coded input data to generate the encrypted input data.

8. The data retransmission device of claim 1, wherein the input data is a digital broadcast signal, and the input data processing unit comprises a decoding unit which decodes the digital broadcast signal, and the decoding unit comprises a copy control information detection module which detects copy control information included in the digital broadcast signal, and an encryption module which encrypts the digital broadcast signal decoded in accordance with detection results of the copy control information detection module.

9. The data retransmission device of claim 1, wherein the input data is analog or digital content input from an external playback device, and the input data processing unit comprises an encoding unit which encodes the analog or digital content, and the encoding unit comprises a copy control information detection module which detects copy control information included in the analog or digital content, and an encryption module which encrypts the analog or digital content encoded in accordance with detection results of the copy control information detection module.

10. The data retransmission device of claim 1, wherein the predetermined bus is a peripheral component interconnect (PCI) bus.

11. The data retransmission device of claim 1, wherein the link protection unit retransmits the encrypted input data to the predetermined device via a wire communication channel.

12. The data retransmission device of claim 1, wherein the link protection unit retransmits the encrypted input data to the predetermined device via a wireless communication channel.

13. A data retransmission method of encrypting input data and retransmitting the encrypted data to a predetermined device, the method comprising:
receiving the input data, coding the input data in a format suitable for the predetermined device to generate coded input data, and encrypting the coded input data with a common key to be shared with the predetermined device in a data input stage to generate encrypted input data; and
receiving the encrypted input data via a predetermined bus and retransmitting the encrypted input data to the predetermined device in a data retransmission stage.

14. The method of claim 13, wherein the receiving of the encrypted input data further comprises creating the common key.

15. The method of claim 14, wherein the receiving of the encrypted input data further comprises encrypting the created common key to generate an encrypted common key, and
wherein the receiving of the input data further comprises receiving the encrypted common key from the data retransmission stage via the predetermined bus, decrypting the encrypted common key, and encrypting the coded input data with the common key which has been decrypted.

16. The method of claim 14, wherein in the receiving of the encrypted input data, the common key is created according to copy control information included in the input data.

17. The method of claim 14, wherein in the receiving of the encrypted input data, the common key is created according to a digital transmission content protection (DTCP) protocol.

18. The method of claim 13, wherein in the receiving of the input data, the input data is encrypted according to copy control information included in the input data.

19. The method of claim 13, wherein the predetermined bus is a peripheral component interconnect (PCI) bus.

20. The method of claim 13, wherein in the receiving of the encrypted input data, the encrypted input data is transmitted to the predetermined device via a wire communication channel.

21. The method of claim 13, wherein in the receiving of the encrypted input data, the encrypted input data is transmitted to the predetermined device via a wireless communication channel.

22. An audio or video (AV) stream information retransmission device for receiving predetermined AV stream information and retransmitting the AV stream information to a predetermined device, the AV stream retransmission device comprising:
a receiving unit which receives the predetermined AV stream information;
a link protection unit which creates a common key through an authentication process with the predetermined device; and
an encryption unit which encrypts the AV stream information using the common key.

23. The AV stream retransmission device of claim 22, wherein the link protection unit encrypts the common key created through the authentication process to generate an encrypted common key, and the encryption unit decrypts the encrypted common key.

24. An audio or video (AV) stream information retransmission method of receiving predetermined AV stream information and retransmitting the received information to a predetermined device, the method comprising:
receiving the predetermined AV stream information;
creating a common key through an authentication process with the predetermined device; and
encrypting the AV stream information using the common key.

25. The method of claim 24, wherein the creating of a common key further comprises encrypting the common key to generate an encrypted common key, and the encrypting of the AV stream information further comprises decrypting the encrypted common key.
